(19) United States
(12) Patent Application Publication
(10) Pub. No.: US 2019/0080626 A1
(43) Pub. Date: Mar. 14, 2019

(54) FACILITATING VOCABULARY EXPANSION

(71) Applicant: International Business Machines Corporation, Armonk, NY (US)

(72) Inventors: Prasenjit Dey, Bangalore (IN); Utkarsh Dwivedi, New Delhi (IN); Ravi Kokku, Yorktown Heights, NY (US); Seema Nagar, Bangalore (IN); Satyanarayana Venkata Nitta, Westchester, NY (US)

(21) Appl. No.: 15/704,460

(22) Filed: Sep. 14, 2017

(51) Int. Cl. G09B 19/00; G06F 17/27; G09B 5/12; G09B 5/06

(52) U.S. Cl. CPC G09B 19/00; G06F 17/278; G09B 5/06; G09B 5/12; G06F 17/2785

(57) ABSTRACT

Techniques are provided that facilitate adaptively expanding vocabulary of an entity. A computer-implemented method is provided that comprises determining, by a device operatively coupled to a processor, one or more areas of a word relationship graph that correspond to a zone of proximal vocabulary development of an entity based on one or more seed words included in a vocabulary associated with the entity. The computer-implemented method can further comprise, identifying, by the device, a set of words included the word relationship graph based on respective words in the set being associated with the one or more areas, and selecting, by the device, a subset of recommended words for learning by the entity from the set of words based on one or more criteria.

### TECHNICAL FIELD

This disclosure relates to facilitating vocabulary expansion of entities.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatus and/or computer program products that provide for facilitating vocabulary expansion.

According to an embodiment of the present invention, a system can comprise a memory that stores computer executable components and a processor that executes the computer executable components stored in the memory. The computer executable components can comprise a vocabulary application component that determines one or more areas of a word relationship graph that correspond to a zone of proximal vocabulary development of an entity based on one or more seed words included in a vocabulary associated with the entity. The computer executable components can further comprise an extraction component that extracts a set of words included the word relationship graph based on respective words in the set being associated with the one or more areas, and a selection component that selects a subset of recommended words for learning by the entity from the set of words based on one or more criteria. In some implementations, the computer executable components further comprise a recommendation component that provides the subset of recommended words to the entity via a device employed by the entity. In another implementation, the computer executable components can comprise a teaching component that facilitates learning of a recommended word included in the subset of recommended words by generating an output that semantically correlates the recommended word with a seed word of the one or more seed words.

In another embodiments, a system is described that can comprise a memory that stores computer executable components and a processor that executes the computer executable components stored in the memory, wherein the computer executable components can comprise a link extraction component that extracts word-link information from a common sense knowledge database based on the word-link information being associated with a target learner profile. The word-link information comprises words and links associated with the words that define relationships between respective words of the words. In some implementations, the target leaner profile comprises entities within a defined age range. The computer executable components can further comprise word filtering component that removes a first subset of the words from the word-link information that are excluded from a word information database comprising a corpus of literature directed to the target learner profile, thereby resulting in partially filtered word-link information comprising filtered words, and a graph generation component that generates a word relationship graph based on the partially filtered word-link information. In one or more implementations, the computer executable components further comprise a link filtering component that removes a second subset of the links from the word-link information that are associated with a level of confusion above a threshold level of confusion, thereby resulting in completely filtered word-link information comprising the filtered words and filtered links, and wherein the graph generation component generates the word relationship graph based on the completely filtered word-link information.

In some embodiments, elements described in connection with the disclosed systems can be embodied in different forms such as a computer-implemented method, a computer program product, or another form.

### DESCRIPTION OF THE DRAWINGS

FIG. 1 illustrates a block diagram of an example, non-limiting system that facilitates entity vocabulary expansion in accordance with one or more embodiments of the disclosed subject matter.

FIG. 2 illustrates is a block diagram of an example, non-limiting subsystem that facilitates developing one or more word relationship graphs catering to a target learner profile in accordance with one or more embodiments of the disclosed subject matter.

FIG. 3 provides a flow diagram of an example, non-limiting computer-implemented method for filtering inappropriate word-links from a word-relationship graph in accordance with one or more embodiments of the disclosed subject matter.

FIG. 4 provides a flow diagram of an example, non-limiting computer-implemented method for filtering inappropriate words and word-links from a word relationship graphs catering to early childhood development in accordance with one or more embodiments of the disclosed subject matter.

FIG. 5 provides a flow diagram of an example, non-limiting computer-implemented method for developing one or more word relationship graphs catering to a target learner profile in accordance with one or more embodiments of the disclosed subject matter.

FIG. 6 provides a flow diagram of an example, non-limiting computer-implemented method for developing one or more word relationship graphs catering to a target learner profile in accordance with one or more embodiments of the disclosed subject matter.

FIG. 7 illustrates is a block diagram of an example, non-limiting subsystem that facilitates determining and recommending words for learning by an entity in accordance with one or more embodiments of the disclosed subject matter.

FIG. 8 illustrates is a block diagram of another example, non-limiting subsystem that facilitates determining and recommending words for learning by an entity in accordance with one or more embodiments of the disclosed subject matter.

FIG. 9 provides a flow diagram of an example, non-limiting computer-implemented method for determining and recommending words for learning by an entity in accordance with one or more embodiments of the disclosed subject matter.

FIG. 10 provides a flow diagram of another example, non-limiting computer-implemented method for determining and recommending words for learning by an entity in accordance with one or more embodiments of the disclosed subject matter.

FIG. 11 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

The subject disclosure provides systems, computer-implemented methods, apparatus and/or computer program products that facilitate entity vocabulary expansion. In particular, the disclosed systems, computer-implemented methods, apparatus and/or computer program products can provide techniques that automatically determine words to recommend to an entity to learn that are appropriate for the entity based on a learning profile of the entity and a word relationship graph tailored to the learning profile. In this regard, the learning profile of the entity can reflect the type and difficulty level of words appropriate for learning by the entity based in part on a level of intellectual development of the entity. For example, in various embodiments, the disclosed techniques can be employed to facilitate vocabulary expansion during early childhood development (ECD). With these embodiments, the learning profile can correspond to developing entities of a defined age range (e.g., eighteen months to six years old). Accordingly, computer-based word analysis and machine learning techniques, among other technical features and solutions, enhance a computer device or computer system's ability to thus automatically determine the words that are recommended to the entity to learn based on the entity's learning profile and the word relationship graph that is tailored to this learning profile.

For example, with respect to ECD, there is no standardized list of words to be taught in early childhood education. Teachers and parents generally determine their own list of important words which they think could be relevant and make entities curious to learn more words by themselves. Further, every entity has a different level of vocabulary based on the environment he/she is raised in. Thus words that may be appropriate for learning by one entity may not be suitable for another. In one or more embodiments described herein, the disclosed techniques can provide approaches to automatically determine and/or suggest the best words to be taught to an entity based in part on the vocabulary level of the entity and the background of the entity. In particular, given a set of words known to the entity, the disclosed techniques provide technological mechanisms to automatically select the next best words related to the known words to learn by the entity so that that entity can learn new words in context. This allows the entity to associate the new words with known words and deepens the vocabulary knowledge of the entity.

The disclosed techniques facilitating entity vocabulary expansion involve two primary components. The first component includes developing one or more word relationship graphs that are tailored to a specific learning profile, referred to herein as the target learner profile or target learner (e.g., entities of a defined age). In one or more embodiments, the one or more word relationship graphs can be developed by curating a common sense knowledge base (KB) to determine words and word-links that are relevant to and appropriate for the target learner profile. This can involve identifying and retaining words occurring in an information corpus created from literature directed to the target learner profile. For example, with respect to ECD, the literature can include books, articles, media for particular entities (e.g., songs and videos converted to text or script form), learning materials for particular entities and the like. In some implementations, inappropriate links for the target learner profile can also be identified and removed by applying supervised machine learning techniques.

The second component involves leveraging the word relationship graph to find next sets of words to be taught to a particular entity associated with the target learner profile (e.g., an entity of the relevant age) based on the entity's zone of proximal development. The term “zone of proximal development,” often referred to as “ZPD,” refers to the difference between what a learner can do without help and what he or she cannot do. In the context of the subject disclosure, an entity's ZPD refers to the set of words and word-links that the entity can likely learn next with some guidance based at least in part on the entity's existing vocabulary knowledge. In one or more embodiments, the entity's ZPD can be determined as applied to the word relationship graph to determine one or more areas (e.g., words or groups of words) of the word relationship graph corresponding to the entity's ZPD. Semantically related words included in the entity's ZPD that are semantically related to one another and/or semantically related to one or more known words of the entity can further be identified. These semantically related words can be recommended to the entity via an adaptive learning application that provides entities with new words to learn by building on the semantic relationships between the new words and known words of the entity.

In some embodiments, the semantically related words can further be filtered and ranked to identify a subset of the semantically related words for recommending to the entity based on one or more criteria, including but not limited to: a degree of the word, determined based on the number of incoming and outgoing links; and relevance of the word to the entity based on a background of the entity, demographics of the entity, preferences of the entity, and the like. Further, in one embodiment, in addition to identifying and recommending semantically related words such that next word recommended to the entity has some semantic relationship with a previous word presented to the entity, the disclosed techniques can facilitate further expanding the entity's vocabulary and engaging the entity by occasionally selecting and recommending unrelated words. In this regard, the disclosed techniques can provide for jumping to random or semi-random areas or words in the word relationship graph to find new words for recommending to the entity. For example, if the entity is learning words in a first subject that are semantically related based on association with the same theme, such as animals, the disclosed techniques can provide for randomly introducing words related to a different theme, such as shoes. In some implementations, the new areas in the word relationship graph that are jumped to can be limited to those still included in the entity's ZPD. In other implementations, new words can be occasionally introduced that are not included in the entity's ZPD. Such random or semi-random graph jumping techniques can be employed to keep the entity's attention or otherwise find new subjects for the entity to learn when the entity has mastered a current subject or otherwise learned all semantically related words of associated with a particular subject.

In various embodiments, the disclosed techniques are exemplified in association with facilitating vocabulary expansion during ECD. With these embodiments, the target learning profile can correspond to entities of a defined age range (e.g., eighteen months to six years old, two to five years old, five to ten years old, etc.). However, it should be appreciated that the disclosed techniques are not restricted to ECD. In this regard, the disclosed techniques can be employed to facilitate vocabulary expansion for a variety of different entities associated with different learning profiles, to entities associated with a specific knowledge field (e.g., physicians, engineers, biologists, etc.), or any other potential group of entities associated with a distinct vocabulary KB.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

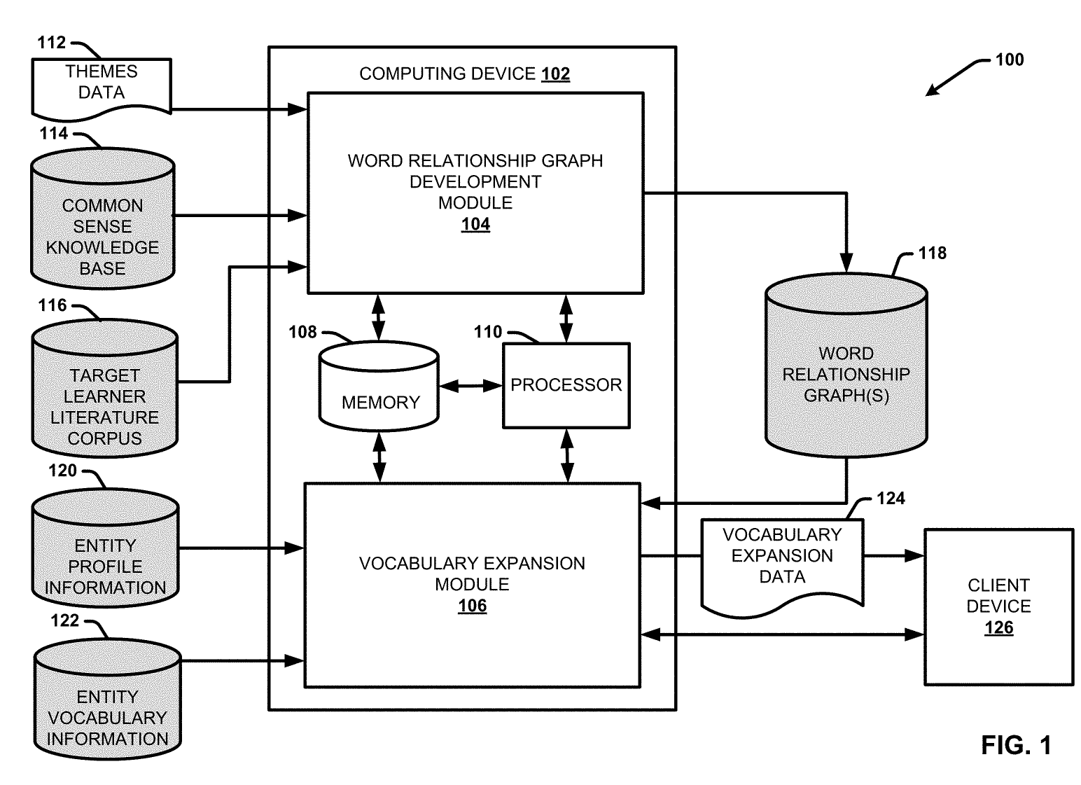

Turning now to the drawings, FIG. 1 illustrates a block diagram of an example, non-limiting system 100 that facilitates entity vocabulary expansion in accordance with one or more embodiments of the disclosed subject matter. System 100 or other systems detailed herein can provide technical improvements to techniques to expand vocabulary knowledge. In this regard, system 100 and/or the components of the system 100 or other systems disclosed herein can develop and/or employ word relationship graphs tailored to a target entity profile to facilitate adaptively determining words for learning by an entity based on the entity's ZPD. In particular, system 100 can curate a common sense KB to create word relationship graph catering to a target learner profile, such as developing entities, and imposing an entity's specific ZPD on the word relationship graph to identify semantically related words included in the entity's ZPD. System 100 can further select next set words from the semantically related words based on one or more criteria, including but not limited to: degree of a word, (computed using incoming and outgoing links), and relevance of a word to the entity (e.g., based on the entity background, demographics, location, preferences, etc.).

System 100 and/or the components of the system 100 or other systems disclosed herein can be employed to use hardware and/or software to solve problems that are highly technical in nature, that are not abstract, and that cannot be performed as a set of mental acts by a human system 100 and/or components of system 100 or other systems described herein can also be employed to solve new problems that arise through advancements in technology, computer networks, the Internet, and the like. For example, system 100 and/or components of system 100 or other systems described herein can access and leverage electronic common sense KBs for any written language via the Internet to facilitate generating word relationship graphs directed to a target learning profile. Further, system 100 and/or components of system 100 or other systems described herein can filter the common sense KBs to automatically extract and identify appropriate words for the target learner profile using a corpus created from literature directed to the target learner profile (e.g., literature for particular entities). Inappropriate word-links can also be automatically identified and removed by training a supervised model on thousands of appropriate links and employing the supervised model to automatically recognize and remove inappropriate links.

Given the vast amount of words and word-links that exist, it would be impossible for a human to identify appropriate words and word-links from a common sense KB and generate a word relationship graph tailored to a target learner profile. For example, even a single word existing in natural language can be linked to hundreds of other words in a common sense KB. Thus extracting appropriate words from the common sense KB based on a corpus created from literature for particular entities cannot possibly be done on pen and paper given the number of words in the common sense KB and the number of words in the corpus, which could be millions. Further, generating a tailored list of words for each and every entity based on their current knowledge of vocabulary using a word relationship graph is humanly impossible. By applying an entity's ZPD to a word relationship graph tailored to the entity's learning profile, the disclosed techniques significantly improve the computational processing time associated with determining and providing entities with semantically related words for learning. Further, some of the processes performed can be performed by specialized computers for carrying out defined tasks related to building an adaptive vocabulary learning experience for early childhood learning by leveraging a word relationship graph for finding next set of words to be taught to an entity based on an entity's ZPD.

Embodiments of systems described herein can include one or more machine-executable components embodied within one or more machines (e.g., embodied in one or more computer-readable storage media associated with one or more machines). Such components, when executed by the one or more machines (e.g., processors, computers, computing devices, virtual machines, etc.) can cause the one or more machines to perform the operations described. For example, in the embodiment shown, system 100 includes a computing device 102 that includes a word relationship graph development module 104 and a vocabulary expansion module 106 which can respectively correspond to machine-executable components. System 100 also includes various electronic data sources and data structures comprising information that can be read by, used by and/or generated by the word relationship graph development module 104 and/or the vocabulary expansion module 106. For example, these data sources and data structures can include but are not limited to: themes data 112, a common sense KB 114, a target learner literature corpus 116, learner profile information 120, entity vocabulary information 122, one or more word relationship graphs 118, and vocabulary expansion data 124.

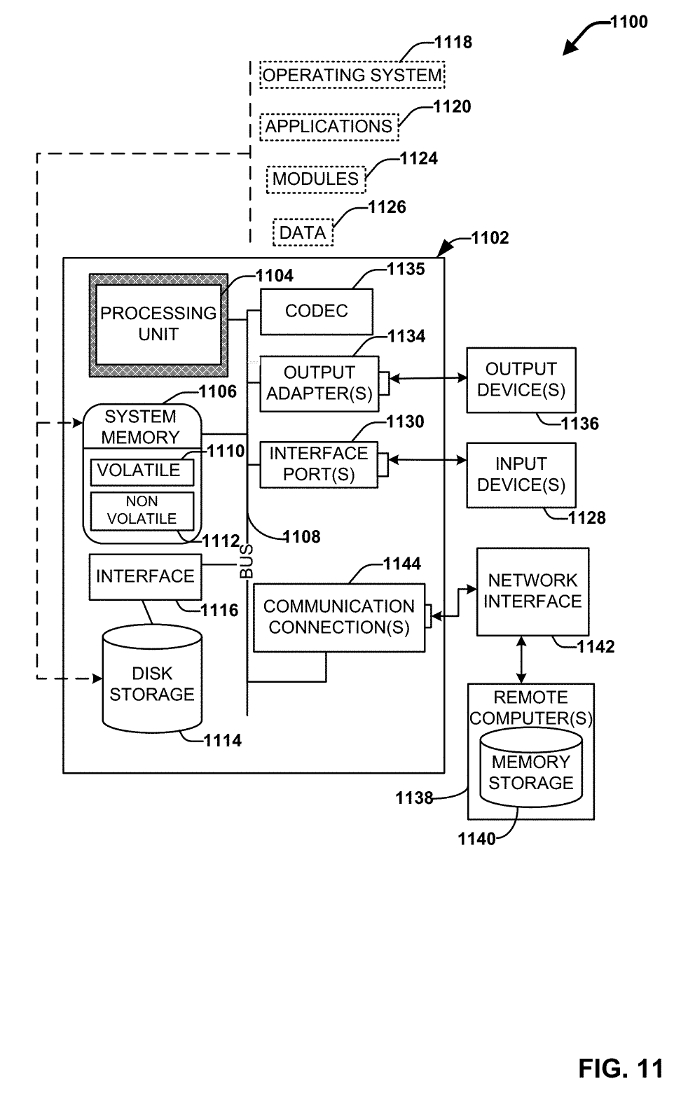

The computing device 102 can include or be operatively coupled to at least one memory 108 and at least one processor 110. The at least one memory 108 can further store executable instructions (e.g., the word relationship graph development module 104 and a vocabulary expansion module 106), that when executed by the at least one processor 110, facilitate performance of operations defined by the executable instruction. In some embodiments, the memory 108 can also store the various data sources and/or structures of system 100 (e.g., the themes data 112, the common sense KB 114, the target learner literature corpus 116, the entity profile information 120, the entity vocabulary information 122, the word relationship graphs 118, and the vocabulary expansion data 124). In other embodiments, the various data sources and structures of system 100 can be stored in other memory (e.g., at a remote device or system), that is accessible to the computing device 102 (e.g., via one or more networks). Examples of said processor 110 and memory 108, as well as other suitable computer or computing-based elements, can be found with reference to FIG. 11, and can be used in connection with implementing one or more of the systems or components shown and described in connection with FIG. 1 or other figures disclosed herein.

System 100 further includes a client device 126. The client device 126 can be communicatively coupled to the computing device 102 to access and receive information (e.g., vocabulary expansion data 124) and/or programs provided by the computing device 102 such an adaptive vocabulary learning application (discussed infra). In some implementations, the computing device 102, the client device 126 and/or the various data sources of system 100 can be communicatively connected via one or more networks. Such networks can include wired and wireless networks, including but not limited to, a cellular network, a wide area network (WAD, e.g., the Internet) or a local area network (LAN). For example, the computing device 102 can communicate with the client device 126 and access the common sense KB 114 (and vice versa) using virtually any desired wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol, and/or other proprietary and non-proprietary communication protocols. The computing device 102 and the client device 126 can thus include hardware (e.g., a central processing unit (CPU), a transceiver, a decoder), software (e.g., a set of threads, a set of processes, software in execution) or a combination of hardware and software that facilitates communicating information between the computing device 102 and the client device 126.

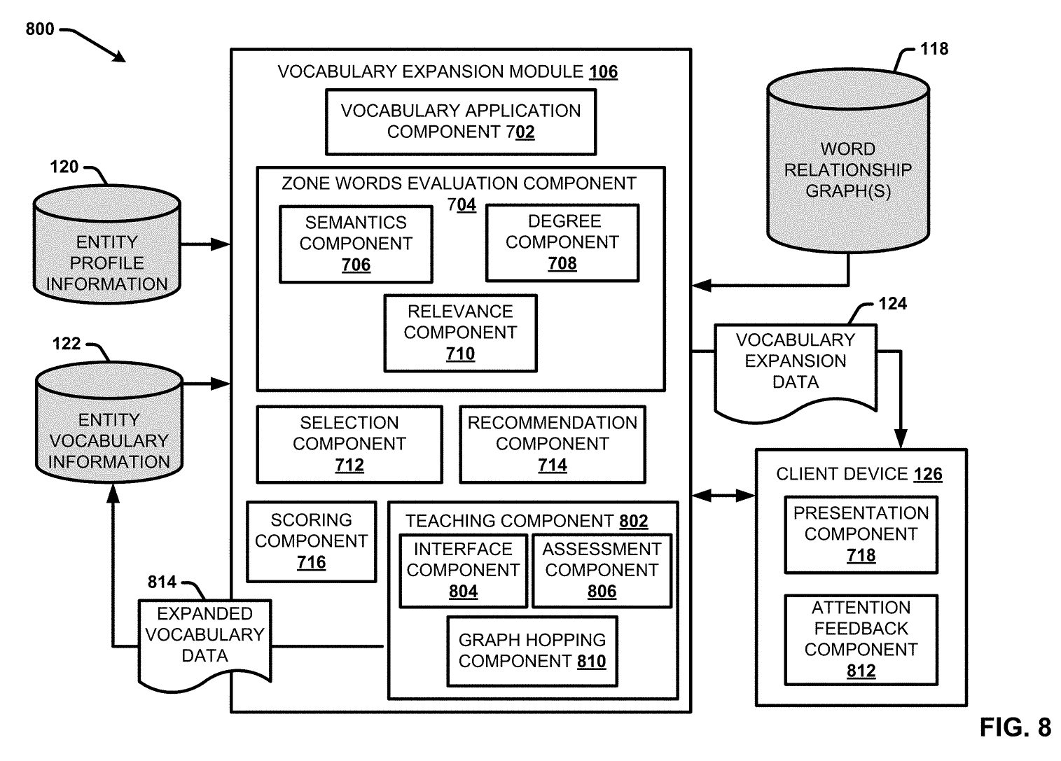

The client device 126 can include any suitable computing device associated with an entity and that can receive and render the vocabulary expansion data 124 (e.g., via a graphical entity interface (GUI), via a speaker if the data includes audio, and the like) provided by the computing device 102. In some implementations, the client device 126 can also facilitate capturing and providing the vocabulary expansion module 106 with feedback information regarding the entity's attention or interest level in association with usage of an adaptive vocabulary expansion application (e.g., as discussed infra with respect to FIG. 8). For example, the client device 126 can include a desktop computer, a laptop computer, a television, an Internet enabled television, a mobile phone, a smartphone, a tablet entity computer (PC), a digital assistant (PDA), a HUD, virtual reality (VR) headset, an augmented reality (AR) headset, or another type of wearable computing device. As used in this disclosure, the terms “entity,” “learner,” “teacher,” “student,” “entity” and the like can refer to a person, system, or combination thereof (or a machine that is composed of software and/or hardware) that can employ system 100 (or additional systems described in this disclosure) using a client device 126 or the computing device 102.

In one or more embodiments, the word relationship graph development module 104 can generate one or more word relationship graphs 118 using the themes data 112, the common sense KB 114 and the target learner literature corpus 116. The themes data 112 can identify one or more themes that a word relationship graph, or a sub-graph within the word relationship graph, can be directed to. In this regard, a theme can provide some common abstraction for which a group of words can be related. For example, different themes can correspond to different target learner profiles defined by one or more distinguishing characteristics such as age, age range, grade level, educational level, and the like. In this regard, the one or more word relationship graphs 118 can include different graphs respectively directed to different target learner profiles. For example, in accordance with various embodiments described herein, the theme for which one or more word relationship graphs 118 are based includes ECD. Different themes can also correspond to different educational subjects or topics, different languages, different categories of words, and the like. For example, in some implementations, different word relationship graphs can be directed to different subjects such as math, science, history, art, shoes, etc. In other implementations, a single word relationship graph can include one or more sub-graphs respectively including clusters or groups of words related by a common theme. For example, a word relationship graph directed to ECD can include one or more sub-graphs with sets of words respectively grouped by different topics, such as animals, foods, shoes, machines, things with wheels, etc.

The common sense KB 114 can include one or more general or granular word relationship databases/graphs that provide different words and identify word-links between respective words. For example, a common sense knowledge database can include a database containing all the general knowledge that most people possess, represented in a way that it is available to artificial intelligence programs that use natural language or make inferences about the ordinary world.

In accordance with one or more embodiments, the word relationship graph development module 104 can extract words and word-links from the common sense KB 114 that are related to one or more particular themes defined by the themes data 112. For example, with respect to ECD, the word relationship graph development module 104 can parse through the common sense KB to identify and extract words and word-links that are appropriate for developing entities (e.g., of a defined age or age range). The word relationship graph development module 104 can further employ the extracted data to generate the one or more corresponding word relationship graphs 118. In one or more embodiments, with respect to a theme that is or includes a specific target learner profile (e.g., developing entities) the word relationship graph development module 104 can identify and extract the related words and word-links from the common sense KB using the target learner literature corpus 116. In this regard, the target learner literature corpus 116 can include an information corpus comprising a collection of words created from literature directed to the target learner profile. For example, with respect to ECD, the literature can include books, articles, media for entities of a particular age (e.g., songs and videos converted to text or script form), learning materials and the like. The word relationship graph development module can 104 thus process the common sense KB 114 by retaining only those words and associated word-links included in the common sense KB 114 that are also included in the target learner literature corpus 116. In some embodiments, the word relationship graph development module can further filter out word-links that are not appropriated for the target learner profile using a supervised learning model (discussed infra).

The word relationship graph development module 104 can further generate one or more word relationship graphs using the extracted and filtered words and word-links that are tailored to the target learner profile. For example, the one or more word relationship graphs can respectively include a plurality of words arranged according to a data structure (e.g., a directed graph) that defines relationships between the words. The relationships between the words are referred to herein as word-links. In this regard, each word-link can represent or describe how two words are semantically related to one another. For example the words potato and market are semantically related in one context because a potato can be found at the market. According to this example, one word-link between the words potato and market can be defined as ‘at location.’ Words and word-links are represented herein according to the following syntax: potato→atLocation→market.

The vocabulary expansion module 106 can employ the one or more word relationship graphs to determine and recommend new words for learning by an entity. In particular, the vocabulary expansion module 106 can employ a word relationship graph directed to a particular target learner profile (e.g., developing entities) to determine and recommend new words for learning by an entity fitting the particular target learner profile (e.g., a developing entity) based on the entity's vocabulary knowledge as determined based on the entity vocabulary information 122. In this regard, the entity vocabulary information 122 can include information regarding a particular entity's vocabulary knowledge. For example, in one implementation, the entity vocabulary information can include words and word-links known to be included in the entity's vocabulary. In another implementation, the entity vocabulary information 122 can include all (or some) of the words included in the word relationship graph and define, for each word (or in some cases one or more), a level of knowledge the entity has for that word. The scale or method for scoring relative knowledge levels of words can vary. For example, in one implementation, a scale of 1-5 can be used wherein a level of 1 indicates the entity completely understands a word and a level 5 indicates the entity has no understanding of the word. In another implementation, the entity vocabulary information 122 can identify a learning level of an entity, wherein the entity can be one of several different learning levels. According to this implementation, each learning level can be associated with a defined set of words considered known by entities of that learning level. For example, each learning level can be associated with a list of known words. In another example, each learning level can be associated with a word difficulty level. According to this example, the difficulty levels of respective words in the word relationship graph can be determined and those words having a difficulty level capable of being understood by the entity can be identified.

In various embodiments, the vocabulary expansion module 106 can select a word relationship graph included in the one or more word relationship graphs 118 that is directed to a target learner profile of a current entity of system 100. The vocabulary expansion module 106 can further determine the entity's ZPD as applied to the word relationship graph to determine one or more areas (e.g., words or groups of words) of the word relationship graph corresponding to the entity's ZPD. The vocabulary expansion module 106 can then determine semantically related words included in the entity's ZPD that are semantically related to one another and/or semantically related to one or more known words of the entity. The vocabulary expansion module 106 can further recommend one or more of the semantically related words to the entity via a client device 126 employed by the entity. For example, in the embodiment shown, the vocabulary expansion data 124 can include the one or more semantically related words selected by the vocabulary expansion module 106 from the word relationship graph. In one implementation, the vocabulary expansion module can provide an adaptive learning application that facilitates learning the vocabulary expansion data 124.

In some embodiments, the vocabulary expansion module 106 can filter and rank the semantically related words to identify a subset of the semantically related words for recommending to the entity based on one or more criteria. This criterion can include for example, a degree of the word, (determined based on the number of incoming and outgoing links), and relevance of the word to the entity based on a background of the entity, demographics of the entity preferences of the entity, and the like. In this regard, the vocabulary expansion module 106 can access and employ entity profile information 120 to facilitate tailoring word recommendations to individual entities. For example, for each entity (or in some cases one or more), the entity profile information 120 can include information regarding but not limited to: a culture of the entity, a location of the entity, a language spoken by the entity, an educational background of the entity, an age of the entity, a learning/intellectual level of the entity, preferences of the entity, and the like.

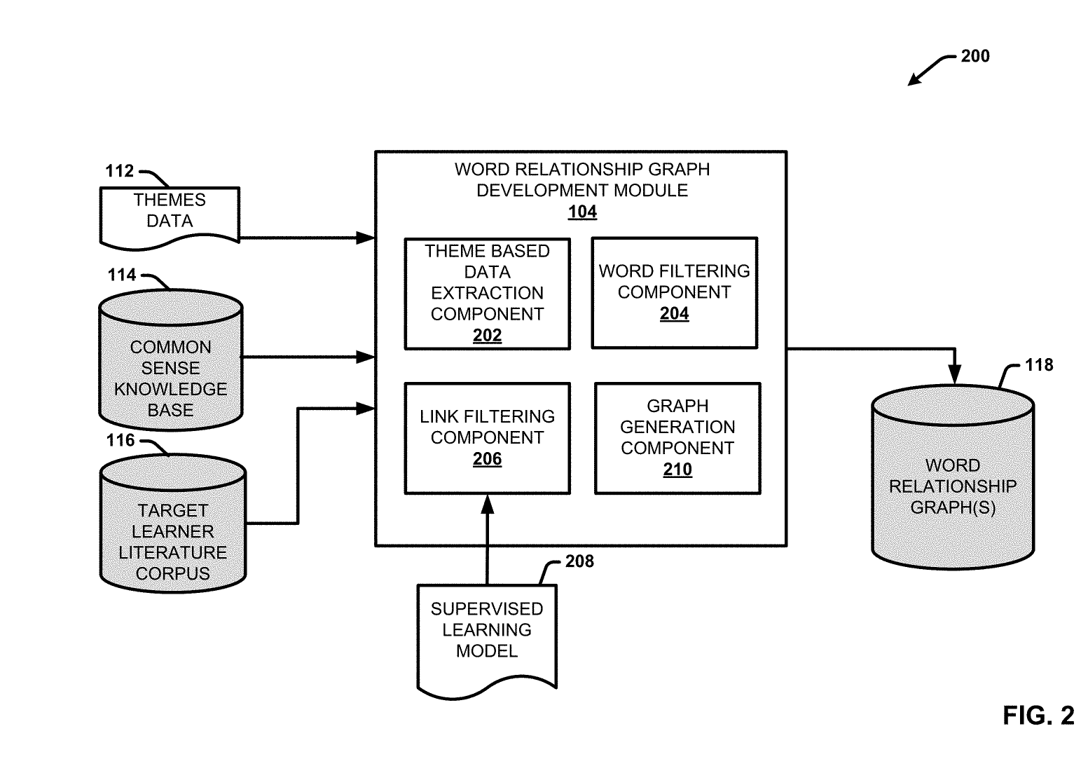

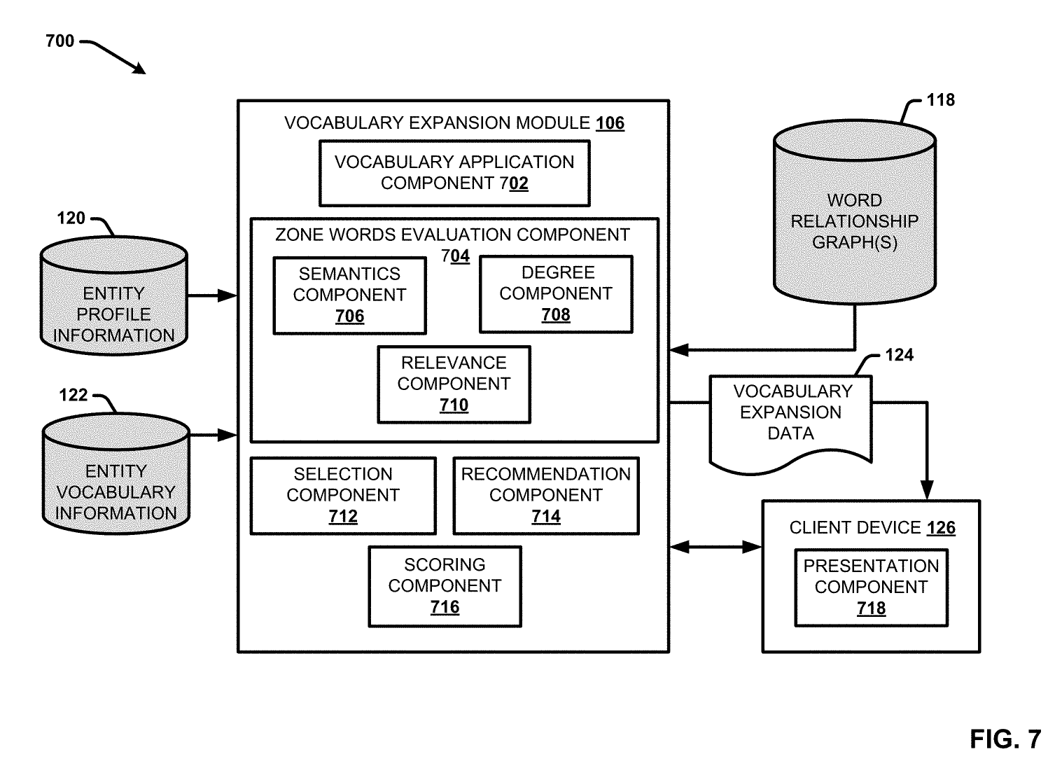

Various additional features and functionalities of the word relationship graph development module 104 are discussed with reference to FIGS. 2-6, and various additional features and functionalities of the vocabulary expansion module 106 are discussed with reference to FIGS. 7-10.

With reference now to FIG. 2, presented is a block diagram of an example, non-limiting subsystem 200 that facilitates developing one or more word relationship graphs catering to a target learner profile in accordance with one or more embodiments of the disclosed subject matter. In various embodiments, subsystem 200 is a subsystem of system 100 (e.g., system 100 can include subsystem 200). For example, subsystem 200 can include the word relationship graph development module 104, the themes data 112, the common sense KB 114, the target learner literature corpus 116 and the word relationship graphs 118. Repetitive description of like elements employed in other embodiments described herein is omitted for sake of brevity.

In the embodiment shown, the word relationship graph development module 104 can include theme based data extraction component 202, word filtering component 204, link filtering component 206 and graph generation component 210. In various embodiments, the theme based data extraction component 202 can filter the common sense KB 114 based on one or more themes identified in the themes data 112 to generate word-link information directed to one or more themes. For example, the theme based data extraction component 202 can extract different sets or groupings of word-link information respectively related to different topics, subjects, categories, etc. In some implementations, the graph generation component 210 can further generate separate word graphs for the different themes. In other implementations, the graph generation component 210 can generate a single word relationship graph with different sub-graphs respectively directed to the different themes.

The word filtering component 204 can process the extracted theme based word-link information to remove inappropriate words for a particular target learner profile. For example, in embodiments in which the target learner profile is a developing entity, the word filtering component 204 can remove words considered inappropriate for entities, such as words considered of high difficulty level (relative to a defined difficulty scale), words associated with profanity, words associated with violence, etc. In various embodiments, the word filtering component 204 can identify and remove inappropriate words for the target learner profile using the target learner literature corpus 116. In this regard, the word filtering component 204 can retain words included in the extracted word-link information that are also included in the target learner literature corpus 116.

The link filtering component 206 can further process the filtered word-link information with the inappropriate words removed to identify and remove word-links that are inappropriate for the target learner profile. Inappropriate word-links can include relationships between two words that could be confusing to the target learner with respect to developing an understanding of what either of the linked words mean. For example, the following word-links could be considered confusing to a young entity learning the respective linked words: cow→atLocation→book, and insect→atLocation→rock. Although a cow could appear in a book and an insect may be located on a rock at some point, these relationships do not provide a deeper understanding of what a cow, book, insect or rock are. These word-links can thus be considered inappropriate for developing entities. Accordingly, an inappropriate word-link can be characterized as a word-link representative of a relationship between two words that provides little or no value with respect to facilitating acquiring knowledge of either of the linked words.

In various embodiments, the link filtering component 206 can employ one or more machine learning techniques to identify and remove inappropriate word-links. For example, in some embodiments, the link filtering component 206 can also evaluate the target learner literature corpus to identify word-links between word pairs. The link filtering component 206 can further examine the identified word-links to determine whether they are consistently and/or frequently used throughout the target learner literature. In this regard, the link filtering component 206 can identify uncommon (e.g., with respect to a threshold value) word-links and remove the uncommon word-links from the extracted data.

In another embodiment, the link filtering component 206 can employ one or more supervised machine learning techniques to identify and remove inappropriate word-links from the extracted data (e.g., data extracted from the common sense KB 114 and partially filtered to remove inappropriate words). For example, in the embodiment shown, subsystem 200 includes a supervised learning model 208 that can be configured to automatically classify word-links with a level of appropriateness (or inappropriateness) for a target learner. In one or more embodiments, the link filtering component 206 can employ the supervised learning model 208 to determine whether a word-link is inappropriate for the target leaner and remove it from the extracted data. For example, based on classification of a word-link with a level of appropriateness less than a minimum level, the link filtering component 206 can remove the word-link from the extracted data.

Supervised learning is the machine learning task of inferring a function from labeled training data. The training data consist of a set of training examples. In supervised learning, each example is a pair consisting of an input object (typically a vector) and a desired output value (also called the supervisory signal). A supervised learning algorithm analyzes the training data and produces an inferred function, which can be used for mapping new examples. An optimal scenario will allow for the algorithm to correctly determine the class labels for unseen instances. This requires the learning algorithm to generalize from the training data to unseen situations in a reasonable way.

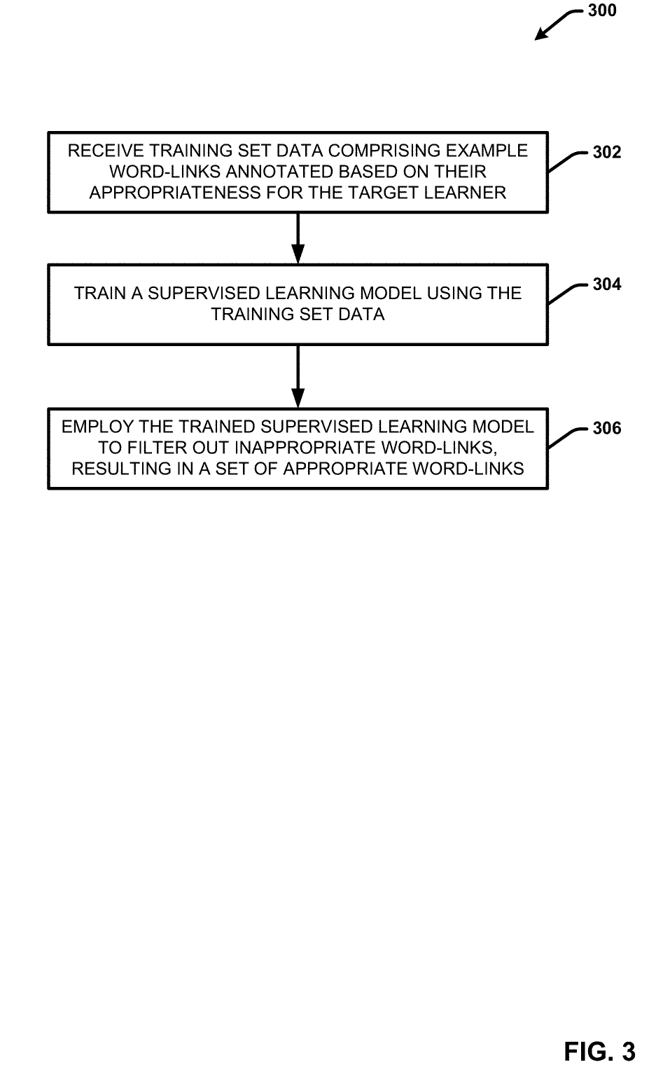

FIG. 3 provides a flow diagram of an example, non-limiting computer-implemented method 300 for employing supervised learning to filter inappropriate word-links from a word-relationship graph in accordance with one or more embodiments of the disclosed subject matter. With reference to FIGS. 2 and 3, in one or more embodiments, the link filtering component 206 can perform or apply method 300 to facilitate identifying and removing inappropriate word-links. At 302, the link filtering component 206 can receive training set data comprising example word-links annotated based on their level of appropriateness for the target learner. For example, in some implementations, the training set data can be manually annotated. At 304, the link filtering component 206 can train a supervised learning model using the training set data. Then at 306, the link filtering component 206 can employ the supervised learning model to filter out inappropriate word-link, resulting in a set of appropriate word-links.

In some implementations, whether a word-link is classified as appropriate or inappropriate for a target leaner can be based on the distances between the two linked words relative to a third word in a common sense KB word-graph that both words are linked to. With these implementations, the link filtering component 206 can classify a word-link as being inappropriate if the cumulative distance is greater than a threshold distance. In this regard, the distance refers to the number of links between two words. For example, in furtherance to the above example with respect to the word-link cow→atLocation→book, a word that could be linked to both cow and book at some point in a word relationship graph could include the word person. For example, the word person could be linked to the word cow in the sense that a person can eat cow products. The word person could also be linked to the term book because a person reads books. Based on the common sense KB word relationship graph, the distance from the term cow to person could be for example 4 hops, and the distance from the word book to person could be for example 3 hops. According to this example, if the maximum distance for a word-link to be considered appropriate is 6 hops, at 7 hops the word-link cow→atLocation→book would be considered inappropriate.

In some embodiments, the link filtering component 206 can also determine and apply the meaning of a word in a word-link pair to identify and filter out word-links that are inappropriate for a particular theme. For example, many words have different meanings depending on the context in which they are used. For instance, the word organ can refer to a musical instrument in one context or a biological part of the human body in another. Thus with respect to a themed word relationship graph or sub-graph directed to the musical arts, the word-link heart→isA→organ would be out of place and inappropriate. Accordingly, in some implementations, the link filtering component 206 can determine the meaning of words included in a word-link pair based on the respective words and the relationship between the words defined by the word-link. Based on the meaning of the one or both words in the pair, the link filtering component 206 can further determine whether the words are related to a particular theme for which a word relationship graph or sub-graph is based. If the words are unrelated (e.g., a bodily organ is not related to musical instruments), the link filtering component 206 can remove the word-link and associated words.

The graph generation component 210 can employ the extracted and filtered words and word-links to generate one or more word relationship graphs 118 that are directed to a target leaner and/or a specific theme. The word relationship graphs can include a plurality of words that are appropriate for learning by the target learner and further define relationships (e.g., word-links) between pairs of words that are useful to understanding the meaning of the respective words.

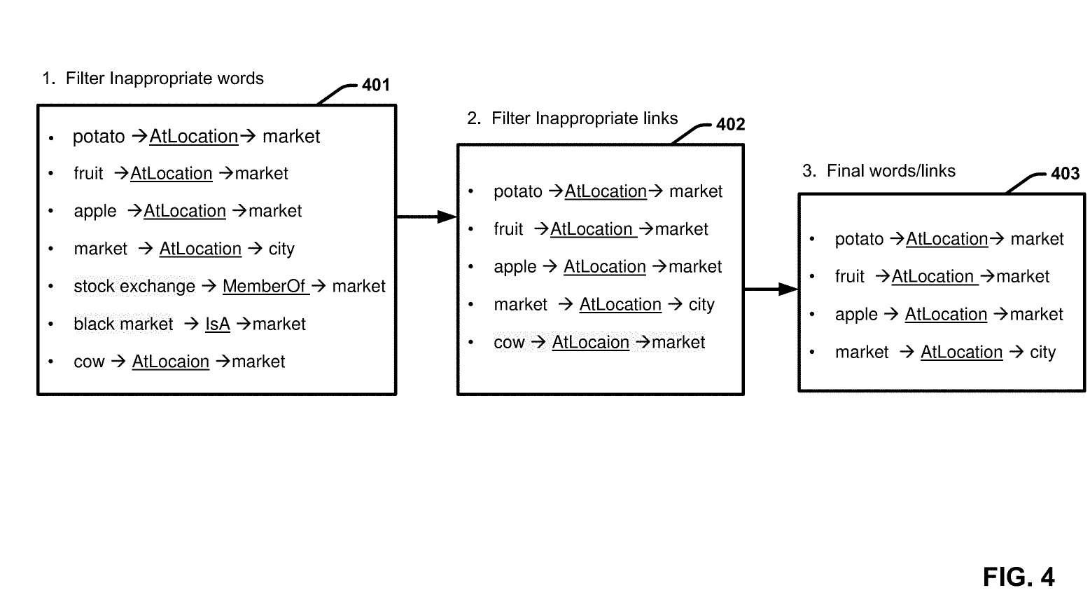

FIG. 4 provides a flow diagram of an example, non-limiting application of the word filtering component 204 and the link filtering component 206 for filtering inappropriate words and links from a word relationship graphs catering to ECD in accordance with one or more embodiments of the disclosed subject matter. Repetitive description of like elements employed in respective embodiments is omitted for sake of brevity.

With reference to FIGS. 2 and 4, in the embodiment shown, block 401 includes seven word-link pairs that can be included in an initial data set extracted by the theme based data extraction component 202. Based on the initial data set, the first filtering step can involve identifying and removing words that are inappropriate for the target learner. In this example, the words stock exchange and black market are highlighted to indicate they are classified as inappropriate. For instance, in some embodiments, the word filtering component 204 can determine that the words stock exchange and black market are inappropriate because they are not present in the target learner literature corpus 116. Block 402 depicts the results of the first filtering step. As shown in block 402, the word-link-pairs including the words stock exchange and black market have been removed. The next filtering step involves the removal of inappropriate links. In this example, the link cow→atLocation→market is highlighted because it is considered inappropriate or confusing for facilitating the target learner's understanding of either the word cow or market. In one or more embodiments, the link filtering component 206 can determine the link cow→atLocation→book is inappropriate based on application of the supervised learning model 208. The results of the second filtering step are shown in block 403.

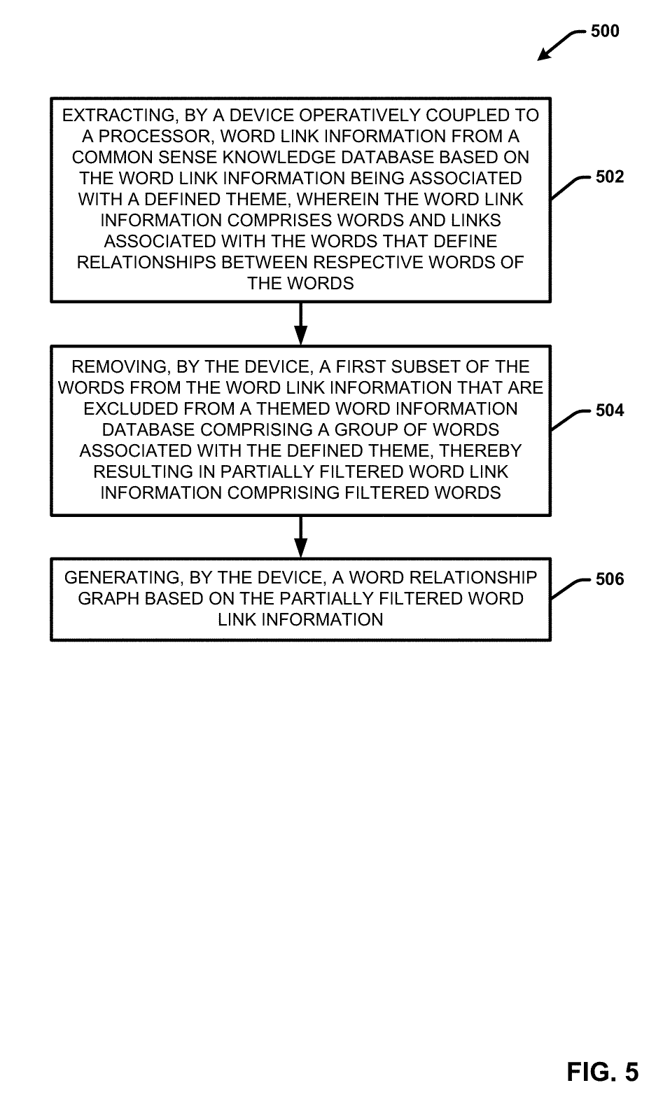

FIG. 5 provides a flow diagram of an example, non-limiting computer-implemented method 500 for developing one or more word relationship graphs catering to a target learner profile in accordance with one or more embodiments of the disclosed subject matter. In one or more embodiments, method 500 can be performed by a suitable computing device (e.g., computing device 102) via application of the word relationship graph development module 104. Repetitive description of like elements employed in respective embodiments is omitted for sake of brevity.

At 502, a device operatively coupled to a processor (e.g., computing device 102) extracts word-link information from a common sense knowledge database (e.g., common sense KB 114) based on the word-link information being associated with a defined theme (e.g., ECD and/or one more granular themes), wherein the word-link information comprises words and links associated with the words that define relationships between respective words of the words. At 504, the device removes (e.g., using word filtering component 204) a first subset of the words from the word-link information that are excluded from a themed word information database comprising a group of words associated with the defined theme (e.g., the target learner literature corpus 116), thereby resulting in partially filtered word-link information comprising filtered words. At 502, the device generates a word relationship graph based on the partially filtered word-link information (e.g., using graph generation component 210).

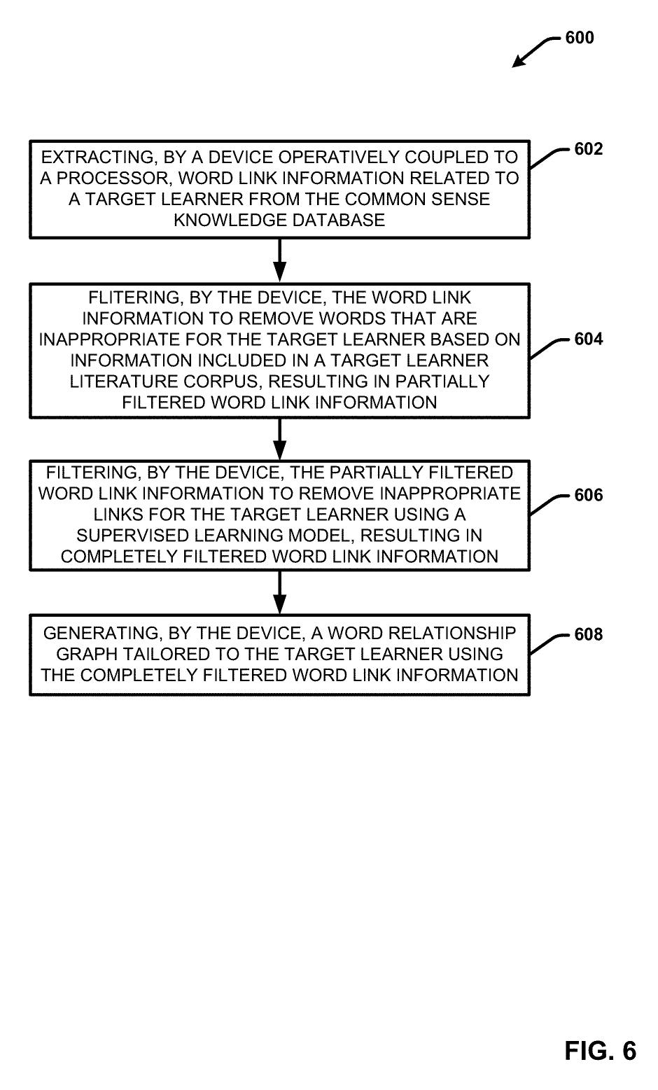

FIG. 6 provides a flow diagram of an example, non-limiting computer-implemented method 600 for developing one or more word relationship graphs catering to a target learner profile in accordance with one or more embodiments of the disclosed subject matter. In one or more embodiments, method 500 can be performed by a suitable computing device (e.g., computing device 102) via application of the word relationship graph development module 104. Repetitive description of like elements employed in respective embodiments is omitted for sake of brevity.

At 602, a device operatively coupled to a processor (e.g., computing device 102) extracts word-link information from a common sense knowledge database (e.g., common sense KB 114) based on the word-link information being related to a target learner (e.g., a developing entity). At 604, the device filters (e.g., using word filtering component 204) the word-link information to remove words that are inappropriate for the target learner based on information included in a target leaner literature corpus (e.g., target learner literature corpus 116), resulting in partially filtered word-link information. At 606, the device further filters (e.g., using the link filtering component 206) the partially filtered word-link information to remove inappropriate links for the target learner using a supervised learning model (e.g., supervised learning model 208), resulting in completely filtered word-link information. At 608, the device generates a word relationship graph using the completely filtered word-link information (e.g., using graph generation component 210).

Turning now to FIG. 7, illustrated is a block diagram of an example, non-limiting subsystem 700 that facilitates determining and recommending words for learning by an entity in accordance with one or more embodiments of the disclosed subject matter. In various embodiments, subsystem 700 is a subsystem of system 100 (e.g., system 100 can include subsystem 700). For example, subsystem 700 can include the vocabulary expansion module 106, the entity profile information 120, the entity vocabulary information 122, the one or more word relationship graphs 118, the vocabulary expansion data 124 and the client device 126. Repetitive description of like elements employed in other embodiments described herein is omitted for sake of brevity.

After the word relationship graph development module 104 has created one or more word relationship graphs 118 that are tailored to a target leaner profile (e.g., developing entities of the ages 18 months to 4 years old), the vocabulary expansion module 106 can employ the one or more word relationship graphs to facilitate identifying and recommending new words for learning by an entity fitting the target learner profile (e.g., a developing entity between the ages 18 months to 4 years old). In the embodiment shown, the vocabulary expansion module 106 can include vocabulary application component 702, zone words evaluation component 704, selection component 712, recommendation component 714, and scoring component 716.

The vocabulary application component 702 can apply an entity's vocabulary information (e.g., as included in entity vocabulary information 122) to a word relationship graph direct to the entity's learning profile to initially determine the entity's ZPD with respect to the words and word-links as included in the word relationship graph. In this regard, based on the entity's vocabulary information, the vocabulary application component 702, the vocabulary application component 702 can determine one or more areas of a word relationship graph that correspond to the entity's ZPD. The one or more areas of the word relationship graph corresponding to the entity's ZPD can respectively include subsets of words and word-links of the word relationship graph that the entity not know or know reasonably well but is likely to learn with reasonable guidance. For example, a primary goal of the vocabulary expansion module 106 is to determine next best words for an entity to learn. In this regard, when an entity has learned a particular word or set of words, the vocabulary expansion module 106 can determine the next set of words that are in the entity's ZPD such that the entity is constantly pushed toward their ZPD. This means, for every word entity knows, the vocabulary expansion module 106 we can identify a ZPD and move the entity to words included in or associated with the ZPD. For example, one particular entity might know ten words, but there are probably about another ten words within the boundary of those ten words as included in the word relationship graph that the entity can learn without too much effort or jump. These additional ten words can be considered the entity's ZPD.

In various embodiment, in order to determine areas of the word relationship graph that correspond to an entity's ZPD, the vocabulary application component 702 can impose the entity's current vocabulary knowledge as defined by the entity's vocabulary information, on the word relationship graph. For example, in one embodiment, the vocabulary application component 702 identify known words included in the entity's vocabulary information, referred to herein as seed words, as included in the word relationship graph. In this regard, the vocabulary application component 702 can determine words included in the word relationship graph that the entity knows. Based on the words that the entity's knows, the zone words evaluation component 704 can determine additional words related to the known words that are included in the entity's ZPD, referred to herein as zone words.

In another embodiment, the vocabulary application component can apply an entity's current vocabulary knowledge information to the word relationship graph to classify respective words included in the word relationship graph with a level of knowledge the entity has for the respective words. The classification scheme can vary and include at least two levels of knowledge. For example, in one implementation, the classification scheme can include a first knowledge level that reflects sufficient knowledge of a word and a second knowledge level that reflects insufficient knowledge of the word (e.g., level 1=known word, level 2=unknown word). In another implementation, the classification scheme can include additional knowledge levels (e.g., levels 1-3, levels 1-5, levels 1-10, etc.), wherein each knowledge level can reflect either more or less knowledge of a word. In some implementations in which the word relationship graph corresponds to a directed graph comprising plurality of connected nodes respectively corresponding to words, the vocabulary application component 702 can apply a coding scheme wherein each word (or one or more words) in the graph can be coded with a level of knowledge the entity has for the word (e.g., green can reflect the word is known well, yellow can reflect the word is partially known, and red can reflect no knowledge of the word). According to this embodiment, based on the knowledge classification level assigned to respective words included in the word relationship graph, the zone words evaluation component 704 can determine which words included in the word relationship graph are zone words or included in the entity's ZPD. For example, in implementations in which the two levels are employed corresponding to known and unknown, all words classified as unknown can be considered zone words. In another example implementation in which two levels are employed corresponding to known and unknown, the vocabulary application component 702 can embody a distance requirement regarding a maximum distance between a known word and an unknown word in the word relationship graph to determine zone words. The distance can correspond to the number of word-links between two words. For example, in one implementation, the vocabulary application component 702 can identify all unknown words that are a one-hop distance (e.g., one word-link), from a known word as being a zone word. In other implementations in which multiple knowledge levels are employed, the vocabulary application component 702 can characterize words having a specific level classification level as being zone words. For example, with respect to a three tier classification scheme including levels 1-3, wherein level 1 indicates full knowledge of a word, level 3 indicates no knowledge of a word, and level 2 indicates some potential knowledge of a word, the vocabulary application component 702 can consider words with a level 2 classification as zone words.

In some implementations, the classification scheme can reflect a level of difficulty of the words. With these implementations, the entity's vocabulary information can include information identifying or indicating a word difficulty level that corresponds to the entity's ZPD. For example, the entity's vocabulary information can include information indicating the entity currently knows words at a difficulty level of 2 or that the entity's ZPD include words with a difficulty level classification of level 3. The vocabulary application component 702 can further determine which words in the word relationship graph are zone words for an entity based on difficulty level classification of the respective words. For example, if the entity currently knows words associated with a difficulty level of level 2, than the vocabulary application component 702 can determine that words classified with a difficulty level of level 3 are zone words. The vocabulary application component 702 can determine a level of difficulty of respective included in the word relationship graph using various techniques. For example, in one embodiment, the vocabulary application component 702 can employ a defined information (e.g., stored in memory 108, associated the word relationship graph, or otherwise accessible to the vocabulary application component 702) that associates difficulty levels with different words.

The zone words evaluation component 704 can further examine the zone words included in or associated with an entity's ZPD to identify one or more subset so of the zone words that are the best next words for the entity to learn. The zone words evaluation component 704 can include semantics component 706, degree component 708 and relevance component 710. The semantics component 706 can evaluate the zone words to identify one or more zone words that are semantically related to one another and/or a seed word that is known to the entity. For example, they can be many different words included in the word relationship graph that are considered within the entity's ZPD that are not semantically related. For instance with respect to a developing entity, the words fish and shoe may be included in the entity's ZPD, by these words are not semantically related. Accordingly, if the entity is currently learning words associated with shoes, the word fish would not be appropriated to introduce, even though it may be part of the entity's ZPD.

In one embodiment, the semantics component 706 can determine semantically related words based on distance between two words, wherein the distance corresponds to a number of word-links between the words. For example, in one implementation, the semantics component 706 can characterize words as being semantically related based on having less than or equal to a maximum number of hops from one another in the word relationship graph. For example, in implementations in which the maximum number of hops is one, the semantics component 706 can classify all words having a single word-link connecting it to specific seed word or zone word as being semantically related. In this regard, based on a particular seed word, or group of seed words, the semantics component can identify a subset of zone words that are semantically related to the seed word or group of seed words based on the semantically related words having a one-hop distance from the seed word or group of seed words. In another implementation, the semantics component 706 can classify zone words with semantic ratings reflective of a degree of semantic relatedness based on the distances between two words. For example, a one-hop distance can be considered a high semantic rating, a two-hop distance can be a medium semantic rating, and a three-hop distance can be a low semantic rating. According to this example, all zone words having more than three hops can be considered semantically unrelated.

In another embodiment, the semantics component 706 can determine semantically related zone word for recommending to an entity based on the zone words being included in or associated with a cluster or family or related words. In this regard, a cluster or family of related words can be characterized as words related by some common theme (e.g., shoes, animals, foods, etc.). Clusters or families of related words can be characterized based on having a plurality of words with dense links. In some implementations, the semantics component 706 can characterize a group of words as corresponding to a cluster or family or related words based on the average distance between respective words in the cluster being less than a threshold distance (e.g., three). In this regard, each word in the cluster would be related to all other words in the cluster by less than or equal to N links, where N is an integer (e.g., 3). In other embodiments, the clusters or families of semantically related words can be defined in the word relationship graph. For example, in some embodiments, the word relationship graph can include two or more sub-graphs, wherein each sub-graph is considered a semantically related cluster of words.

In addition to identifying semantically related zone words (e.g., semantically related to a seed word and/or to one another), the degree component 708 can also evaluate the degree of the zone words to identify zone word that are considered important words for learning as a stepping stone to other words. In this regard, the degree of a word can reflect the number of incoming links to and outgoing links from the word. Association of a high incoming or outgoing degree with a word can indicate the word is more common than lower degree words. In this regard, common words can be representative of concepts that are related to a lot of other words, and vice-versa. Accordingly, words can be scored to reflect their degree and words with high degree scores can be used to define and/or identify vocabulary learning pathways.

For example, with reference back to FIG. 4, the word market is directly connected to many different words. For instance, with reference to block 403, the word market is shown with having three incoming links and one outgoing link. According to this example, the word market can be considered to have a degree of four which corresponds to the total number of incoming and outgoing links. On the other hand a word like camouflage is more distinct and has fewer direct relations to other words. According to this example, the word market could be considered more important to learn before the word camouflage. In some embodiments, the degree component 708 can determine the degree of a zone word (e.g., the total number of incoming and outgoing links) and classify zone words as being either central words, (meaning they have many incoming/outgoing links and thus a high degree), or discrete words, (meaning they have few incoming/outgoing links and thus a low degree), based on the degree of the word. For example, words having a degree greater than X (e.g., 5) can be considered central words and words having a degree less than X or less than Y (e.g., 2) can be considered discrete words. In other embodiments, the degree component 708 can simply determine the degree of the zone words and words having higher degree can be favored by the selection component 712 in association with selecting one or more zone words for recommending to an entity to learn next.

In addition to the semantic relatedness and degree of a potential word for recommending, the relevance component 710 can also evaluate the relevance of a word to a particular entity based on the entity's profile information as included in the entity profile information 120. In this regard, the relevance component 710 can use information included in the entity's profile regarding the entity's background, demographics, preferences and the like to determine a degree of relevance of a word to the particular entity. In this regard, word directed to games played in the country of the entity can be associated with a higher degree of relevance compare to word directed to other games. Similarly, food eaten in the country of the entity can get higher importance compared to other food types. Further, words in the preferences of the entity can be considered more relevant than other words. For example, marshmallows are foods that are popular in America but uncommon in another country. Accordingly, the relevance component 710 can determine that the word marshmallow is not relevant to entity that is raised in another country. In some embodiments, the relevance component 710 can employ defined information associating different entity parameters regarding entity backgrounds, demographics, preferences and the like to determine which words are more or less relevant to different entities. In some implementations, the relevance component 710 can also employ one or more machine learning techniques to determine the degree of relevance of different words to different parameters regarding entity backgrounds, demographics, preferences and the like.

The selection component 712 can select a subset of next best zone words for learning by an entity based on one or more criteria. For example, in one implementation, the selection component 712 can select and recommend all identified zone words to an entity for learning. However, in other embodiments, the selection component 712 can select a subset of the zone words for recommending to the entity based on their semantic relationship to one or more seed words and/or one or more other zone words, the degree of the zone word and/or the relevance of the zone word to the entity based on the entity profile information 120. In some embodiments, the scoring component 716 can score potential zone words for recommending to the entity based on all three criteria. In particular, the scoring component 716 can employ a scoring function that determines a score for a word based on its degree of semantic relatedness to a seed words and/or one or more other zone words, its degree (e.g., number of incoming/outgoing links), and is degree of relevance to the entity. The selection component 712 can further select the subset of zone words for recommending to the entity based on their respective scores. For example, in one implementation, the selection component 712 can select a subset of zone words for recommending to the entity for learning based on the respective zone words in the subset having the K highest scores applied by the scoring component (e.g., the top 3, top 5, top 10, etc. scored words). In various embodiments, zone words having a high semantic relationship, a high degree and a high amount of relevance to the entity can be favored. In some embodiments, the scoring component 716 can weight different criteria differently. For example, the scoring component 716 can weigh the degree of a word higher than its semantic relationship to a seed word, or vice versa. In another embodiment, the scoring component 716 can score word seed words having a high semantic relationship to a seed word and having a low degree better than zone words having a high semantic relationship to the seed word and a high degree. For example, with this embodiment, considering the word-link pairs ‘market→AtLocation→city,’ and ‘potato→AtLocation→market,’ the word line pair ‘market→AtLocation→city’, if the entity knows the term market and thus market is the seed word, the scoring component 716 can score the words potato and city to determine which word to recommend for learning by the entity next. With this embodiment, the word city can have a higher degree than the word potato. Thus the relationship ‘potato→AtLocation→market’ can be considered more unique and thus a better next word to relate it to market rather than word city since the word potato word is more appropriate for reinforcing the learning of the word market.

The recommendation component 714 can further recommend a selected zone word or subset of zone words to the entity. For example, in some implementations, the recommendation component 714 can provide the selected zone word or zone words to the entity via a GUI generated and presented at the client device 126 via the presentation component 718. In another implementation, the recommendation component 714 can provide the selected zone word or zone words to the entity in an audible format that is played back at the client device 126.

FIG. 8 illustrates is a block diagram of another example, non-limiting subsystem 800 that facilitates determining and recommending words for learning by an entity in accordance with one or more embodiments of the disclosed subject matter. Subsystem 800 can include same or similar features and functionality as subsystem 700 with the addition of teaching component 802 to the vocabulary expansion module, attention feedback component 812 to the client device 126 and expanded vocabulary data 814. Repetitive description of like elements employed in respective embodiments is omitted for sake of brevity.

In some embodiments, the teaching component 802 can provide an adaptive learning application that provides entities with new words to learn by building on the semantic relationships between the new words and known words of the entity. In this regard, the teaching component 802 can facilitate learning one or more recommended zone words by generating an output that semantically correlates a zone word with a seed word (e.g., a know word to the entity). For instance, in furtherance to the example above wherein the entity know the word market and the selection component selects the word potato as next best word for learning by the entity, the teaching component 802 can generate and output that can be presented to the entity that semantically correlates the word market and potato. For example, based the teaching component 802 can generate an output including the following sentence: “One of the things that is available in a Market is a Potato. Interested in seeing a Potato?” The teaching application can further allow for receiving entity input, such as a request indicating the entity is interested in seeing a potato. The teaching application can further provide the entity with a picture of video demonstrating what a potato look like, and how a heap how a heap of potatoes look at a market.

In one or more embodiments, the teaching component 802 can provide various interactive adaptive vocabulary building services to an entity via to entity via a suitable network accessible platform. For example, in some implementations, presentation component 718 can include an application (e.g., a web browser) for retrieving, presenting and traversing information resources on the World Wide Web. According to this aspect, the teaching component 802 can provide an interactive adaptive vocabulary building application to entities via a website platform that can be accessed using a browser provided on their respective client devices (e.g., client device 126). In another implementation, the teaching component 802 can provide an interactive adaptive vocabulary building application to entities via a mobile application, a thin client application, a thick client application, a hybrid application, a web-application and the like. Still in other implementations, one or more components of the vocabulary expansion module 106 can be provided at the client device 126 and accessed directly in an offline mode.

In the embodiment shown, the teaching component 802 can include interface component 804, assessment component 806 and graph hopping component 810. The interface component 804 can configure and/or provide an interactive GUI that facilitates presenting entities with new words, and providing entities with text and/or image data correlating the new words to one or more known words of the entity. The GUI can also facilitate receiving entity input selecting new words to learn and/or indicating a level of knowledge the entity has gained in a new word. For example, in one implementation, the interactive adaptive vocabulary building application can include a gaming application that provides tests for the entity to perform and/or respond to that can gauge an entity's level of understanding of a word. The assessment component 806 can further assess an entity's level of knowledge of new words as they are provided to the entity and the entity learns them using the adaptive learning application. For example, the assessment component 806 can determine if and when an entity has gained sufficient knowledge of a recommended zone word such that it can be added to the entity's vocabulary. The new words can be added to the entity's existing entity vocabulary information (e.g., entity vocabulary information 122) as expanded vocabulary data 814. In some embodiments, as new words are added, the vocabulary application component 702 can also recalculate and expand the entity's ZPD as applied to the word relationship graph.

In some embodiments, using the interactive adaptive vocabulary building application, an entity can learn all words included in a semantically related cluster of family of zone words associated with a selected seed word or group of seed words. In this regard, the recommendation component 714 can essentially reach an end in the word relationship where additional semantically related words in that cluster or family are not available. In other implementations, an entity can become bored or otherwise disengaged in association with learning a group or family of semantically related words. With these implementations, the assessment component 806 can determine or infer in and when an entity is getting bored or losing attention based on their rate of response/interaction with the application. In other embodiments, the client device 126 can include attention feedback component 812 to monitor an entity's attention level based on one or more additional parameters measurable at the client device, including sensory feedback regarding an entity's facial expression, body position, body language, mental state, gaze direction, and the like. The attention feedback component 812 can further provide the graph hopping component 810 within information indicative of the entity's attention levels.

In either of these scenarios, the teaching component 802 can employ the graph hopping component 810 to randomly or semi-randomly select new words in the word relationship graph for learning by the entity. For example, based on a determination that entity has learned all semantically related words in a cluster or family of semantically related words, the graph hopping component 810 can jump to a random different cluster or family of related words for teaching to the entity. In another example, based on detection that an entity's attention level has dropped below a threshold level, the graph hopping component 810 can select a random area in the graph from which to pull new words for recommending the entity to learn. In some implementations, the new words can include zone words that are located in different areas of the graph that are not semantically related to a previous cluster or family of words being learned by the entity. In other implementations, the new word can include words out of the entity's ZPD.

Still in other implementations, the graph hopping component 810 can be configured to randomly select non-semantically related zone word for introducing to the entity at random points throughout usage of the adaptive learning application and/or upon the occurrence of other trigger events. For example, in one implementation, the scoring component 716 can occasionally (e.g., in a random fashion) remove the semantic relatedness criterion from a scoring function employed to score zone words. In other implementations, the scoring component 716 can remove the semantic relatedness criterion from a scoring function employed to score zone words in response to a determination that entity is learning a lot of new words at a quick rate, in response to the entity failing to learn new words at a minimal rate, or another trigger event.

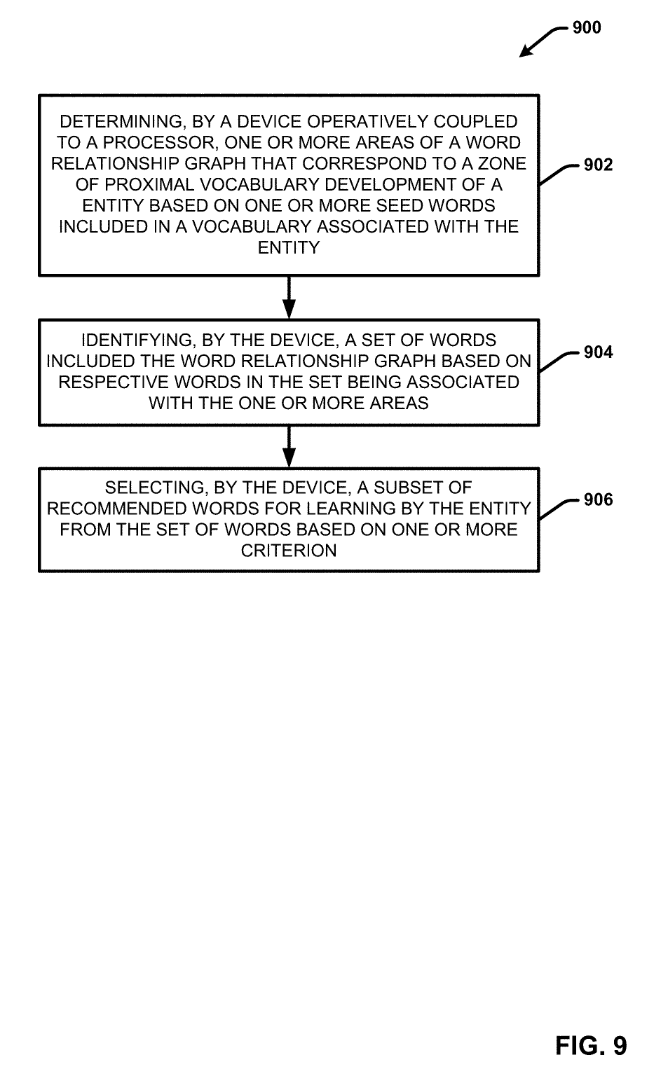

FIG. 9 provides a flow diagram of an example, non-limiting computer-implemented method 900 for determining and recommending words for learning by an entity in accordance with one or more embodiments of the disclosed subject matter. Repetitive description of like elements employed in respective embodiments is omitted for sake of brevity.

At 902, a device operatively coupled to a processor (e.g., computing device 102), determines one or more areas of a word relationship graph that correspond to a zone of proximal vocabulary development of an entity based on one or more seed words included in a vocabulary associated with the entity (e.g., using vocabulary application component 702). At 904, the device identifies a set of words included the word relationship graph based on respective words in the set being associated with the one or more areas (e.g., using zone words evaluation component 704). At 906, the device selects a subset of recommended words for learning by the entity from the set of words based on one or more criteria (e.g., using selection component 712).

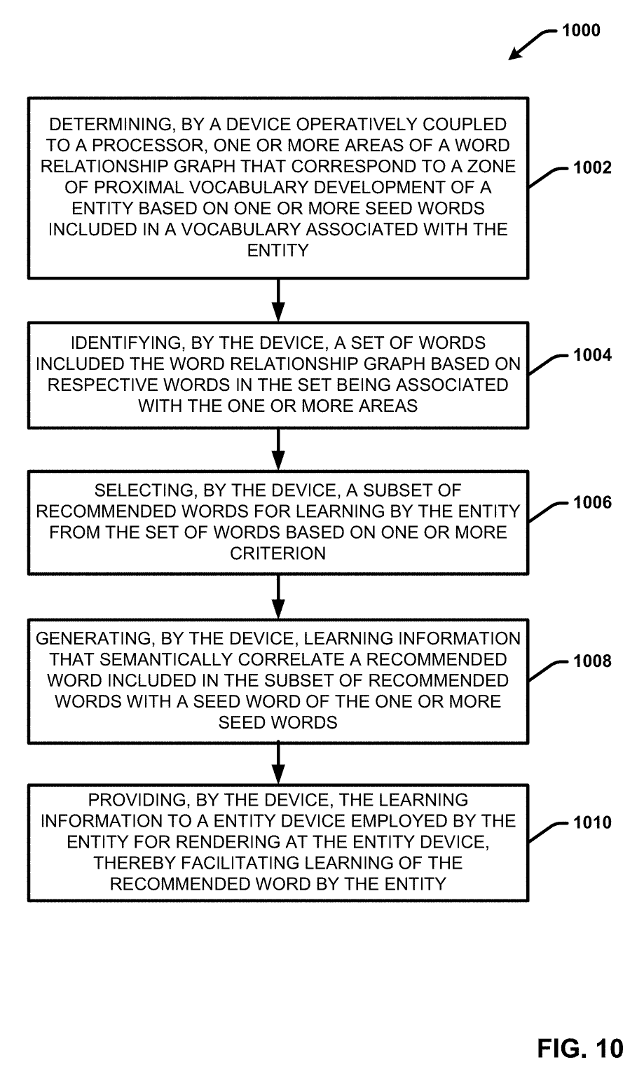

FIG. 10 provides a flow diagram of an example, non-limiting computer-implemented method 1000 for determining and recommending words for learning by an entity in accordance with one or more embodiments of the disclosed subject matter. Repetitive description of like elements employed in respective embodiments is omitted for sake of brevity.

At 1002, a device operatively coupled to a processor (e.g., computing device 102), determines one or more areas of a word relationship graph that correspond to a zone of proximal vocabulary development of an entity based on one or more seed words included in a vocabulary associated with the entity (e.g., using vocabulary application component 702). At 1004, the device identifies a set of words included the word relationship graph based on respective words in the set being associated with the one or more areas (e.g., using zone words evaluation component 704). At 1006, the device selects a subset of recommended words for learning by the entity from the set of words based on one or more criteria (e.g., using selection component 712). At 1008, the device generates learning information that semantically correlate a recommended word included in the subset of recommended words with a seed word of the one or more seed words (e.g., via teaching component 802). At 1010, the device provides (e.g., via teaching component 802) the learning information to an entity device (e.g., client device 126) employed by the entity for rendering at the entity device, thereby facilitating learning of the recommended word by the entity.

One or more embodiments can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the entity's computer, partly on the entity's computer, as a stand-alone software package, partly on the entity's computer and partly on a remote computer or entirely on the remote computer or server. In the latter scenario, the remote computer can be connected to the entity's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It can be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In connection with FIG. 11, the systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which can be explicitly illustrated herein.

With reference to FIG. 11, an example environment 1100 for implementing various aspects of the claimed subject matter includes a computer 1102. The computer 1102 includes a processing unit 1104, a system memory 1106, a codec 1135, and a system bus 1108. The system bus 1108 couples system components including, but not limited to, the system memory 1106 to the processing unit 1104. The processing unit 1104 can be any of various available processors. Dual microprocessors and other multiprocessor architectures also can be employed as the processing unit 1104.

The system bus 1108 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1106 includes volatile memory 1110 and non-volatile memory 1112, which can employ one or more of the disclosed memory architectures, in various embodiments. The basic input/output system (BIOS), containing the basic routines to transfer information between elements within the computer 1102, such as during start-up, is stored in non-volatile memory 1112. In addition, according to present innovations, codec 1135 can include at least one of an encoder or decoder, wherein the at least one of an encoder or decoder can consist of hardware, software, or a combination of hardware and software. Although, codec 1135 is depicted as a separate component, codec 1135 can be contained within non-volatile memory 1112. By way of illustration, and not limitation, non-volatile memory 1112 can include read only memory (ROM), programmable ROM (PROM), electrically programmable ROM (EPROM), electrically erasable programmable ROM (EEPROM), Flash memory, 3D Flash memory, or resistive memory such as resistive random access memory (RRAM). Non-volatile memory 1112 can employ one or more of the disclosed memory devices, in at least some embodiments. Moreover, non-volatile memory 1112 can be computer memory (e.g., physically integrated with computer 1102 or a main board thereof), or removable memory. Examples of suitable removable memory with which disclosed embodiments can be implemented can include a secure digital (SD) card, a compact Flash (CF) card, a universal serial bus (USB) memory stick, or the like. Volatile memory 1110 includes random access memory (RAM), which acts as external cache memory, and can also employ one or more disclosed memory devices in various embodiments. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM) and so forth.

Computer 1102 can also include removable/non-removable, volatile/non-volatile computer storage medium. FIG. 11 illustrates, for example, disk storage 1114. Disk storage 1114 includes, but is not limited to, devices like a magnetic disk drive, solid state disk (SSD), flash memory card, or memory stick. In addition, disk storage 1114 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1114 to the system bus 1108, a removable or non-removable interface is typically used, such as interface 1116. It is appreciated that disk storage 1114 can store information related to an entity. Such information might be stored at or provided to a server or to an application running on an entity device. In one embodiment, the entity can be notified (e.g., by way of output device(s) 1136) of the types of information that are stored to disk storage 1114 or transmitted to the server or application. The entity can be provided the opportunity to opt-in or opt-out of having such information collected or shared with the server or application (e.g., by way of input from input device(s) 1128).

It is to be appreciated that FIG. 11 describes software that acts as an intermediary between entities and the basic computer resources described in the suitable operating environment 1100. Such software includes an operating system 1118. Operating system 1118, which can be stored on disk storage 1114, acts to control and allocate resources of the computer system 1102. Applications 1120 take advantage of the management of resources by operating system 1118 through program modules 1124, and program data 1126, such as the boot/shutdown transaction table and the like, stored either in system memory 1106 or on disk storage 1114. It is to be appreciated that the claimed subject matter can be implemented with various operating systems or combinations of operating systems.

An entity enters commands or information into the computer 1102 through input device(s) 1128. Input devices 1128 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1104 through the system bus 1108 via interface port(s) 1130. Interface port(s) 1130 include, for example, a serial port, a parallel port, a game port, and a universal serial bus (USB). Output device(s) 1136 use some of the same type of ports as input device(s) 1128. Thus, for example, a USB port can be used to provide input to computer 1102 and to output information from computer 1102 to an output device 1136. Output adapter 1134 is provided to illustrate that there are some output devices 1136 like monitors, speakers, and printers, among other output devices 1136, which require special adapters. The output adapters 1134 include, by way of illustration and not limitation, video and sound cards that provide a means of connection between the output device 1136 and the system bus 1108. It should be noted that other devices or systems of devices provide both input and output capabilities such as remote computer(s) 1138.

Computer 1102 can operate in a networked environment using logical connections to one or more remote computers, such as remote computer(s) 1138. The remote computer(s) 1138 can be a personal computer, a server, a router, a network PC, a workstation, a microprocessor based appliance, a peer device, a smart phone, a tablet, or other network node, and typically includes many of the elements described relative to computer 1102. For purposes of brevity, only a memory storage device 1140 is illustrated with remote computer(s) 1138. Remote computer(s) 1138 is logically connected to computer 1102 through a network interface 1142 and then connected via communication connection(s) 1144. Network interface 1142 encompasses wire or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1144 refers to the hardware/software employed to connect the network interface 1142 to the bus 1108. While communication connection 1144 is shown for illustrative clarity inside computer 1102, it can also be external to computer 1102. The hardware/software necessary for connection to the network interface 1142 includes, for exemplary purposes only, internal and external technologies such as, modems including regular telephone grade modems, cable modems and DSL modems, ISDN adapters, and wired and wireless Ethernet cards, hubs, and routers.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration and are intended to be non-limiting. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of entity equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations can be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor that executes the computer executable components stored in the memory, wherein the computer executable components comprise:
a vocabulary application component that determines one or more areas of a word relationship graph that correspond to a zone of proximal vocabulary development of an entity based on one or more seed words included in a vocabulary associated with the entity;
an evaluation component that identifies a set of words included in the word relationship graph based on respective words in the set of words being associated with the one or more areas; and
a selection component that selects a subset of recommended words for learning by the entity from the set of words based on one or more criteria.

2. The system of claim 1, wherein the computer executable components further comprise:
a recommendation component that provides the subset of recommended words to the entity via a device employed by the entity.

3. The system of claim 1, wherein the computer executable components further comprise:
a teaching component that facilitates learning of a recommended word included in the subset of recommended words by generating an output that semantically correlates the recommended word with a seed word of the one or more seed words.

4. The system of claim 1, wherein the vocabulary application component identifies the one or more seed words as included in the word relationship graph and classifies the one or more seed words with a level of knowledge the entity has for the one or more seed words respectively, wherein the level of knowledge is selected from at least two levels of knowledge, including a first level of knowledge and a second level of knowledge, and wherein the first level of knowledge corresponds to a higher level of knowledge relative to the second level of knowledge.

5. The system of claim 4, wherein the vocabulary application component determines the one or more areas based on the one or more areas respectively comprising a seed word of the one or more seed words having a classification of the second level of knowledge.

6. The system of claim 1, wherein the evaluation component identifies the set of words based on the respective words in the set of words being related to one or more words included in the one or more areas by a single degree of separation in the word relationship graph.

7. The system of claim 1, wherein the evaluation component identifies the set of words based on the respective words in the set of words being included in a cluster of words collectively characterized as having a low degree of separation in the word relationship graph relative to one or more other clusters of words in the word relationship graph, and based on at least some of words in the cluster of words overlapping with the one or more areas.

8. The system of claim 1, wherein the one or more criteria comprise word degree representative of number of incoming links to and outgoing links from a word, wherein a greater number of the incoming links to and outgoing links from the word reflects a higher degree and higher level of commonality of the word relative to a lower number of the incoming links to and outgoing links from the word.

9. The system of claim 1, wherein the one or more criteria comprise a degree of relatedness of respective recommended words included in the subset of recommended words to one or more profile characteristics of the entity.

10. The system of claim 9, wherein the one or more profile characteristics are selected from a group consisting of: a demographic characteristic of the entity, a location of the entity, and a preference of the entity.

11. The system of claim 1, wherein the computer executable components further comprise:
a scoring component that determines scores for the respective words included in the set of words based on the one or more criteria, wherein the scores reflect a degree of suitability of the respective words for learning by the entity, and wherein the selection component selects the subset of recommended words based on the scores.

12. The system of claim 11, wherein the one or more criteria comprise a number of incoming links to and outgoing links from the respective words, and a degree of relatedness of the respective words to one or more profile characteristics of the entity.

13. The system of claim 1, wherein the word relationship graph comprises a plurality of words associated with a defined theme and defines respective relationships between the plurality of words.

14. A system, comprising:
a memory that stores computer executable components;
a processor that executes the computer executable components stored in the memory, wherein the computer executable components comprise:
a link extraction component that extracts word-link information from a common sense knowledge database based on the word-link information being associated with a target learner profile, wherein the word-link information comprises words and links associated with the words that define relationships between respective words of the words;
a word filtering component that removes a first subset of the words from the word-link information that are excluded from a word information database comprising a corpus of literature directed to the target learner profile, thereby resulting in partially filtered word-link information comprising filtered words; and
a graph generation component that generates a word relationship graph based on the partially filtered word-link information.

15. The system of claim 14, wherein the computer executable components further comprise:
a link filtering component that removes a second subset of the links from the word-link information that are associated with a level of confusion above a threshold level of confusion, thereby resulting in completely filtered word-link information comprising the filtered words and filtered links, and wherein the graph generation component generates the word relationship graph based on the completely filtered word-link information.

16. The system of claim 15, wherein the link filtering component employs a supervised machine learning algorithm to determine the second subset of the links that are associated with the level of confusion above the threshold level of confusion.

17. The system of claim 15, wherein the word relationship graph relates the filtered words to one another based on the filtered links.

18. The system of claim 14, wherein the target learner profile comprises an entity within a defined age range.

19.-20. (canceled)
